(19) United States
(12) Patent Application Publication
(10) Pub. No.: US 2008/0126245 A1
(43) Pub. Date: May 29, 2008

(54) SYSTEM AND METHOD FOR CENTRALIZED BANKING

(76) Inventor: Robert Rosenberg, Brooklyn, NY (US)

Correspondence Address: OSTROLENK FABER GERB & SOFFEN, 1180 AVENUE OF THE AMERICAS, NEW YORK, NY, 100368403, US

(21) Appl. No.: 11/563,779

(22) Filed: Nov. 28, 2006

(51) Int. Cl. G06Q 40/00

(52) U.S. Cl. 705/39; 705/35

(57) ABSTRACT

A system and method is disclosed for providing personal financial services at a single branch location for customers having accounts at a plurality of private financial institutions. First and second customer provide information representing their respective private financial accounts. The accounts may be held at different institutions. The branch location provides personal financial services to enable the first customer and the second customer to conduct transactions for their respective accounts. Preferably, a network of branches locations are provided that are each operable to provide personal bank services for a plurality of accounts held at a plurality of private financial institutions.

1 Field of the Invention

The present invention relates generally to personal financial services, and, more specifically, to providing personal financial services from one bank branch for a plurality of financial institutions.

2. Description of the Related Art

The banking industry strives to make and implement technological advances in order to improve and increase options for current and potential customers, and to remain competitive. By providing customer service options as a function of technology, banks realize cost savings by reducing the workforce previously required for servicing customers. For example, bank account withdrawals, deposits, transfers, bill payments, and a plethora of other customer service options are provided to customers without any human (i.e., bank teller) interaction with the customer.

In the prior art, banks typically provide automated customer service in two ways: on a computer located at the bank's premises (e.g., an automatic teller machine (“ATM”)), or via a secure internet web site available to any customer equipped with a computing device operating a web browser software application. Of course, certain transactions, such as cash withdrawals, cannot be performed via an internet web site, but internet web sites, nevertheless, provide a significant menu of options for bank customers, including bill payments, transfers, inquiries, or the like.

Notwithstanding the many prior art advantages provided by technological offerings, the importance of local bank branches staffed with humans who are there to help and assist customers, continues to be of very high importance. For example, many banks attract new customers through their local branches, and many customers will only bank at institutions that have a local branch in their neighborhood, where they can purchase money orders, apply for loans, clarify discrepancies in their statements by dealing with live people, etc. Besides, the aforementioned automated banking services retain shortcomings that result in customer dissatisfaction and frustration. Some of the dissatisfaction bank customers experience stem from high bank fees and low personal service. Too often, personalized bank services, such as those provided by a bank teller, are only provided for additional fees, while corresponding services provided on an ATM or over the internet carry no additional charges. Also, customers are typically charged additional fees to use one bank's ATM to perform bank operations associated with an account held at another bank. For example, a CHASE bank customer may be charged $2.00 per transaction to use an ATM located at a WACHOVIA bank branch.

Furthermore, some bank transactions (such as deposits) can only be executed at an ATM located at a branch of a particular bank. Banks do not, typically, accept deposits in automatic teller machines (or even in person) for accounts held at different banks.

Another shortcoming of prior art banking is that each bank has a limited number of bank branch locations, and, particularly of smaller banks, many of these locations are located in a particular geographic region. Therefore, if a customer requires personal financial service, e.g., services provided by a teller or officer, the customer must physically go to a branch owned by that bank during the branch's hours of operation.

Further, the cost associated with providing various technological offerings is extremely high, and not every primary financial institution can compete to provide services associated therewith. Financial institutions that cannot compete by providing a broad range of technological offering may result in customers leaving the institution in favor of another. Thus, a primary financial institution may lose holders of bank accounts, mortgages or other loans, or may lose prospective customers.

### SUMMARY OF THE INVENTION

The present invention recognizes these and other shortcomings experienced by banking customers.

The present invention comprises a system and method which enables a single banking branch office to act as the “local bank branch” of many different banking institutions. The “local bank branch” of the present invention typically displays a branch sign listing the many different banks for which it serves as a local branch. The chameleon like computer system at such local bank branch is able to assume the “personality” of any of the various bank clients to serve the needs of any member banking customer. Thus a bank teller need only instruct his/her computer console which bank system to impersonate, and thereafter the system gains access to the records and data of the requested bank. Thus, the system of the present disclosure is able to provide personal financial services for different customers having accounts at different financial institutions. Preferably, a network of such branch locations are provided, each with its site processor. The branch locations receive account information representing account data pertaining to a plurality of customers at the plurality of private financial institutions. The branch locations provide the personal financial services to enable customers having accounts at different banks to conduct transactions for their respective accounts at the same local branch.

Other features and advantages of the present invention will become apparent from the following description of the invention that refers to the accompanying drawings.

### BRIEF DESCRIPTION OF THE DRAWINGS

For the purpose of illustrating the invention, there is shown in the drawings a form which is presently preferred, it being understood, however, that the invention is not limited to the precise arrangements and instrumentalities shown. The features and advantages of the present invention will become apparent from the following description of the invention that refers to the accompanying drawings, in which:

FIG. 1 is a diagram of an arrangement of parties constructed in accordance with the present invention;

FIG. 2 is a diagram of an example hardware arrangement constructed in accordance with the present invention;

FIG. 3 is a block diagram of the functional elements of a network connecting device used in accordance with the present invention;

FIG. 4 is a flow chart that illustrates steps associated with registering customers with a proprietor of the present invention; and

FIG. 5 is a block diagram illustrating example personal financial services that are provided to customers 106 at branch 102 in accordance with a preferred embodiment.

### DETAILED DESCRIPTION OF THE INVENTION

In a preferred embodiment, a network of bank branches are provided, wherein each of the branches provide personal financial services, by simultaneously representing a plurality of banks. Customers who use one of the branches of the present invention are preferably able to conduct transactions that affect their respective bank accounts held at various different primary financial institutions, such as savings and loans institutions, credit unions, community banks, stock brokerages, or the like.

In accordance with the present invention, customers are not required to visit their respective primary financial institution in order to conduct transactions and/or receive personal financial services. Customers can, instead, visit a branch provided in accordance with the present invention and conduct respective account transactions, particularly those requiring personal financial services. Although accounts remain at the customer's primary financial institution (referred to herein, generally as a “PFI”), customers preferably can conduct any and all transactions in the branch of the present invention. Thus, in one embodiment, the branch functions as a conduit for the PFI and respective account transactions are conducted on behalf of the respective financial institutions that hold the accounts.

In this way, a single branch may provide personal financial services for a virtually unlimited number of financial institutions, thereby increasing the number of branches and hours of operation for a customer to conduct account transactions.

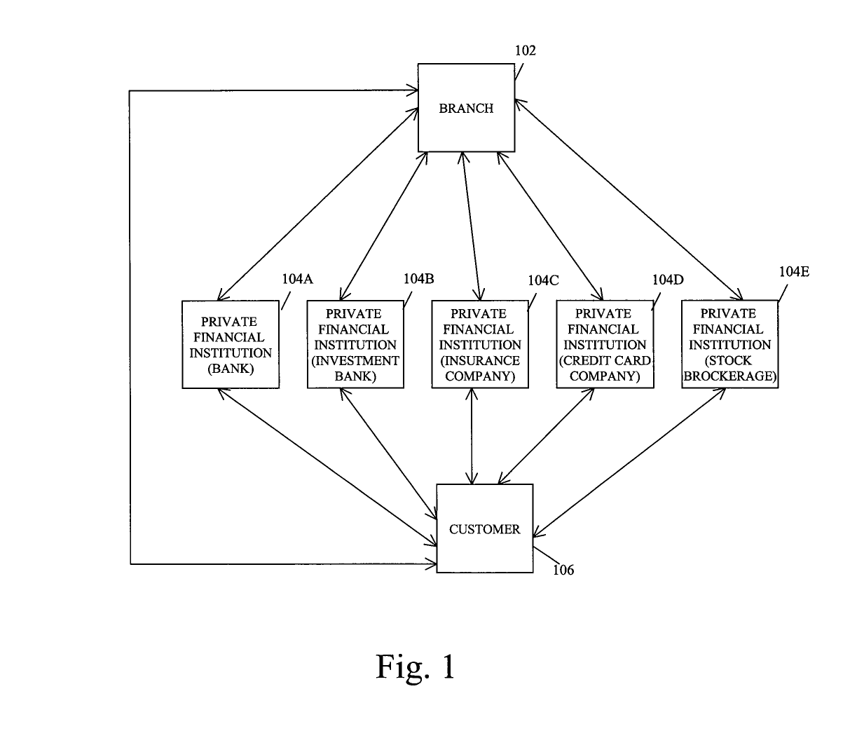

Referring to the reference figures in which like reference numerals refer to like elements, there is shown in FIG. 1 an example arrangement of parties in accordance with a preferred embodiment. As shown in FIG. 1, branch 102 operates to provide personal financial services for primary financial institution 104. As shown in FIG. 1, primary financial institutions 104 include may include any provider of financial services, and include banks 104A, investment banks 104B, insurance companies 104C, credit card companies 104D and stock brokerages 104E. Customers 106 have accounts at the various primary financial institution 104, and use branch 102 to conduct transactions particular to any the various institutions 104.

In a preferred embodiment, branch 102 is more than simply a conduit or facade for a plurality of primary financial institutions 104. Branch 102 is preferably a bank or other financial institution in its own right, and operates to accept deposits and may use deposited money for various into lending activities.

As used herein, the term, “module,” refers, generally, to one or more discrete components that contribute to the effectiveness of the present invention. Modules can include software elements, including but not limited to functions, algorithms, classes and the like. Modules also include hardware elements, substantially as described below. Modules can operate independently or, alternatively, depend upon one or more other modules in order to function.

Also as used herein, the term personal financial services refers, generally, to any services that enables a customer to execute instructions associated with a bank account (e.g., checking, savings or the like), loans and mortgages, insurance, credit management, taxes or the like. Personal financial services preferably include services provided by bank personnel, such as tellers.

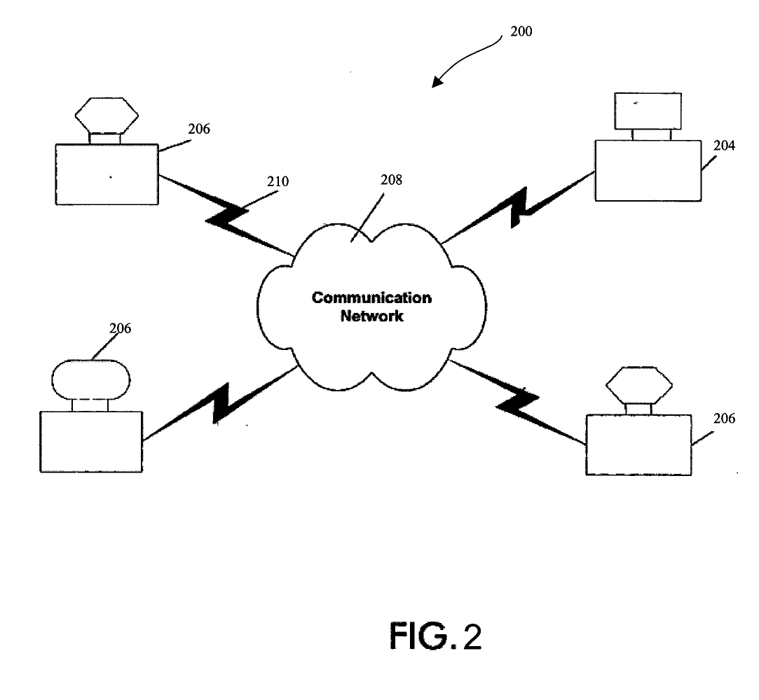

FIG. 2 shows a diagram of an example hardware arrangement system constructed in accordance with the present invention, and designated generally as “system 200.” System 200 is preferably comprised of one or more site processors 204 coupled to one or more workstations 206 across communication network 208.

Site processor 204 preferably includes all necessary databases for the present invention. However, it is contemplated that site processor 204 can access any required databases via communication network 208 or any other communication network to which site processor 204 has access. Site processor 204 can communicate devices comprising databases using any known communication method, including a direct serial or parallel interface, or via a local or wide area network.

Workstations 206 communicate with site processors 204 using data connections 210, which are respectively coupled to communication network 208. Communication network 208 can be any communication network, but is typically the Internet or some other global computer network. Data connections 210 can be any known arrangement for accessing communication network 208, such as dial-up serial line interface protocol/point-to-point protocol (SLIPP/PPP), integrated services digital network (ISDN), dedicated leased-line service, broadband (cable) access, frame relay, digital subscriber line (DSL), asynchronous transfer mode (ATM) or other access techniques.

Workstations 206 preferably have the ability to send and receive data across communication network 208, and are equipped with web browsers to display the received data on display devices incorporated therewith. By way of example, workstation 206 may be personal computers such as Intel Pentium-class computers or Apple Macintosh computers, but are not limited to such computers. Other terminals which can communicate over a global computer network such as palmtop computers, personal digital assistants (PDAs) and mass-marketed Internet access devices such as WebTV can be used. In addition, the hardware arrangement of the present invention is not limited to devices that are physically wired to communication network 208. Of course, one skilled in the art will recognize that wireless devices can communicate with site processors 204 using wireless data communication connections (e.g., WIFI).

In addition to computer-related methods to access the system 200, parties who are not able to access the system 200 via a computer or related device can write physical letters, make telephone calls or facsimiles to parties operating in accordance with the present invention. For example, after a letter and/or telephone call is received, data-entry personnel make the necessary entries into system 200.

According to the present invention, workstation 206 provides user access to site processor 204 for the purpose of receiving and providing financial-related information. The specific functionality provided by system 200, and in particular site processors 204, is described in detail below.

System 200 employs software that controls financial transaction functions and preferably resides on one or more site processors 204. One of the functions performed by site processor 204 is that of operating as a web server and/or a web site host. Site processors 204 typically communicate with communication network 8 across a permanent i.e., unswitched data connection 210. Permanent connectivity ensures that access to site processors 204 is always available.

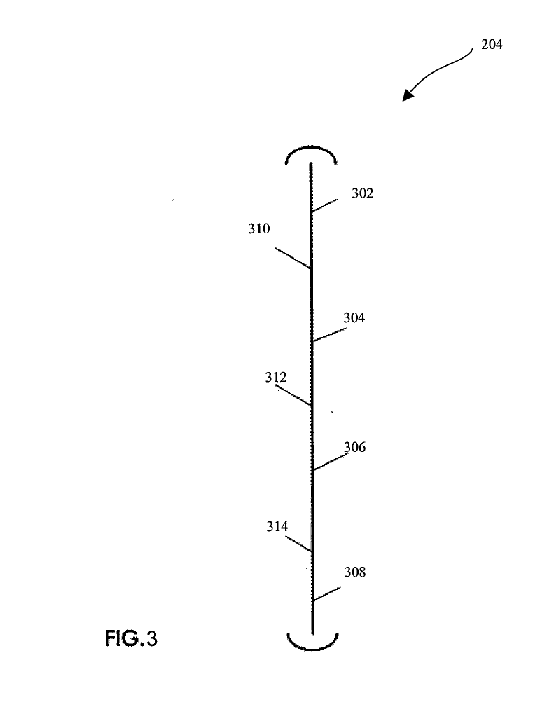

As shown in FIG. 3, the functional elements of each site processor 204 preferably include one or more central processing units (CPU) 302 used to execute software code in order to control the operation of site processor 204, read only memory (ROM) 304, random access memory (RAM) 306, one or more network interfaces 308 to transmit and receive data to and from other computing devices across a communication network, storage devices 310 such as a hard disk drive, floppy disk drive, tape drive, CD-ROM or DVD drive for storing program code, databases and application code, one or more input devices 312 such as a keyboard, mouse, track ball and the like, and a display 314. Display 314 may be formatted as a touch screen device, thereby acting as a combination device 312 and 314.

The various components of site processor 204 need not be physically contained within the same chassis or even located in a single location. For example, as explained above with respect to databases which can reside on storage device 310, storage device 310 may be located at a site which is remote from the remaining elements of site processors 204, and may even be connected to CPU 312 across communication network 208 via network interface 308.

The functional elements shown in FIG. 3 (designated by reference numbers 302-314) are preferably the same categories of functional elements preferably present in workstation 206. However, not all elements need be present, for example, storage devices in the case of PDAs, and the capacities of the various elements are arranged to accommodate expected user demand. For example, CPU 302 in workstation 206 may be of a smaller capacity than CPU 302 as present in site processor 204. Similarly, it is likely that site processor 204 will include storage devices 310 of a much higher capacity than storage devices 310 present in work station 206. Of course, one of ordinary skill in the art will understand that the capacities of the functional elements can be adjusted as needed.

The nature of the present invention is such that one skilled in the art of writing computer executed code (software) can implement the described functions using one or more or a combination of a popular computer programming language including but not limited to “C++”, Visual Basic, Java, ActiveX, HTML, XML, SOAP and web application development environments.

As used herein, references to displaying data on workstation 206 refer to the process of communicating data to the terminal across communication network 208 and processing the data such that the data can be viewed on the workstation display 314 using a web browser or the like. The display screen on workstation 206 presents areas within system 200 such that a user can proceed from area to area within the system 200 by selecting a desired link. Therefore, each user's experience with system 200 will be based on the order with which they progress through the display screens. In other words, because the system is not completely hierarchical in its arrangement of display screens, users can proceed from area to area without the need to “backtrack” through a series of display screens. For that reason, unless stated otherwise, the following discussion is not intended to represent any sequential operation steps, but rather the discussion of the components of system 2.

It is contemplated that system 200 can be arranged such that workstation 206 can communicate with, and display data received from, site processor 4 using any known communication and display method, for example, using an Internet web browser application or a non-Internet browser Windows viewer coupled with a local area network protocol such as the Internetwork Packet Exchange (IPX). It is further contemplated that any suitable operating system can be used on workstation 6, for example, Windows 3.x, Windows 95, Windows 98, Windows CE, Windows NT, LINUX and any suitable PDA or palm computer operating system.

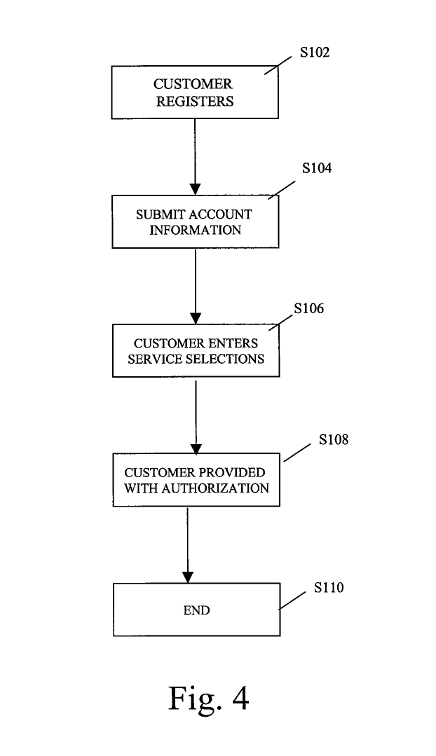

The invention is now further described with reference to a flow chart in FIG. 4 that illustrates registering customers 106 with a proprietor of the present invention.

Each customer 106 preferably registers with the proprietor of the present invention to be availed of the features described herein (step S102). For example, customer 106 submits an information form (either electronically or in paper) that identifies the PFI 104 account(s) that the customer 106 would like branch 102 to effect transactions for (step S104). For example, the customer 106 submits his name, address, telephone numbers (home, work, cell or other), PFI 104 account numbers, PFI 104 name, PFI 104 address and branch where the account(s) were opened, PFI 104 representative that is familiar is with the account(s) and PFI 104 telephone number. Further, the customer 106 submits information representing various contact preferences, such as a preferred contact time and telephone number (e.g., cellular telephone number, business telephone number or home telephone number). Customers 106 also submit information representing selections of personal financial services that the customer 106 would like to be provided at branch 104 (step S106). For example, customer 106 selects financial services related to pick up and delivery, or whether customers 106 will allow others to cash customer's 106 checks at branch 102. After customer 106 has completed his selections, customer 106 is provided with internet authorization information, such as a user identification and password, as well as a personal bank card to be used to identify the customer and for ATM bank transactions (step S108). At step S110, the registration process ends.

Preferably, customers 106 have an option to sign up for membership in branch 102 and get approved immediately. If, for some reason, membership can not be completed immediately, customers 106 are given an option for deposit transactions to leave with branch 102, and receive an “in escrow” receipt, pending final approval for membership.

In a preferred embodiment software operates on site processor 204 to record personal financial services, including various account transactions and immediately generates electronic information representing the services. The information is preferably processed (e.g., formatted) and transmitted to a customer's 106 respective PFI 104 in a format that is compatible to PFI's computer software applications. Moreover, information representing customer's 106 account may be obtained from the customer's 106 PFI 104, and site processor 204 preferably processes the information received therefrom. For example, information that frequently changes (e.g. account balances) is requested by site processor 204 and the customers' 106 PFIs 104 transmit the information to site processor 204. Other information that remains essentially static, such as a customer's account information is obtained during registration, as described above with reference to FIG. 4, and that information is preferably stored for future use.

In an alternative embodiment, site processor 204 does not request information to be transmitted from each customer's 106 PFI 104. Instead, a customer's 106 PFI 104 authorizes site processor 204 to access the PFI's 104 databases, and information is retrieved therefrom and entered thereto instantaneously.

In a preferred embodiment, customers 106 enter branch 102 location and can proceed to a branch 102 teller. The teller preferably identifies the customer 106 by any of various methods. For example, the teller reviews an ID card issued to the customer during the registration process (FIG. 4). Alternatively, the teller reviews a bank card (or ATM card) issued by the customer's 102 PFI 104. Alternatively, any available technologies of smart devices in items of personal belongings can be used to identify the customer 102 as a registered member of the present invention. Other measures of identifying customer 102 may be used, including electronically reading the customer's 102 fingerprint, other biometric identification, receiving account information including PFI name and codes assigned by site processor 204 to the customer's 106 respective PFI 104. Further, customers 102 may submit a transaction slip, such as a deposit slip, withdrawal slip or the like, that includes information enabling the teller to recognize customer 102 as a registered customer and to provide personal financial services. Thus, in accordance with the teachings herein, customers 106 can be identified and recognized by branch 102 tellers in order to enable tellers to perform personal financial transactions at branch 102.

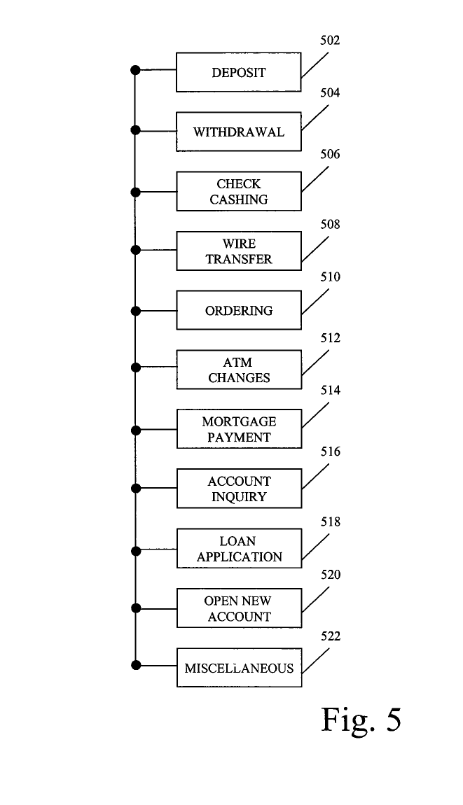

FIG. 5 is a block diagram illustrating example personal financial services that are provided to customers 106 at branch 102 in accordance with a preferred embodiment. As shown in FIG. 5, deposit 502, withdrawal 504, check cashing 506, wire transfer 508, ordering 510, ATM card changes 512 mortgage payment 514, balance inquiry 516, loan applications 518 and new accounts 520 are all examples of personal financial services provided in accordance with a preferred embodiment. Further miscellaneous services 522, such as described below, are also preferably provided.

Continuing with reference to FIG. 5, customer 106 can make deposits 502 for checks, cash, foreign currency, coins or the like. In practice, customer 106 preferably hands the branch 104 teller the deposit, including a deposit slip and items to be deposited, and the teller either scans a bar code on deposit slip or manually enters information on a computer. Preferably, the customer's 106 name and PFI 104 is displayed on the branch 104 teller's display 314. In case customer 106 is identified by other methods, such as described above, than customer's 106 information also appears immediately upon being identified. In case during the registration process (or any time thereafter) customer 106 has identified several accounts that are to be available in accordance with the teachings herein, then all accounts preferably appear on touch screen display 314 and either customer 106 or the teller selects a respective for the deposit. Preferably, any checks included in a deposit are scanned during the deposit process. In one embodiment and for efficiency purposes and to keep tellers available for other customers, check scanning is performed by a different clerk. Moreover, any scanned images are preferably forwarded immediately to the customer's 106 PFI 104.

After a deposit, customer 106 may receive a receipt from the branch 102 teller indicating that the branch 102 received the deposit on behalf of the customer's 106 PFI 104. The receipt preferably includes the PFI 104 account number and current gross and available balance in the customer's 106 account. At the customer's 106 option, the customer 106 may wait a short period of time until any scanning process, for example, of checks being deposited, is complete and then receive a receipt that includes the scanned images. Alternatively, customer 106 can receive the scanned images by email, or the customer 106 may download the scanned images from a web site provided by site processor 104.

Continuing with reference to FIG. 5, customers 106 can use branch 102 to make withdrawals 504. Withdrawals can be in the form, for example, of cash, coins, bank checks (certified/official) and/or foreign currency. Preferably, customer 106 submits information, such as on a withdrawal slip or other form of ticket that includes a withdrawal request and indicating the form of the withdrawal (e.g., cash certified/official check, etc.). In case the withdrawal is in cash, customer 106 preferably completes information such as amount of withdrawal and the respective account where the withdrawal is to be made. Customer 106 also has an option of indicating denominations of bills. In case the withdrawal is to provided as a certified/official check, customer 106 preferably indicates the amount of certified/official check and site processor 104 confirms the transaction with the customer's 106 PFI 104, and further confirms the withdrawal of funds. Thereafter, the branch 102 teller provides the funds. In case the withdrawal is a check, the branch prints a check drawn on the customer's 106 PFI 104 that contains all required information from the respective PFI 104, thereby enabling funds to come directly from the PFI 104. In an alternative embodiment, the respective PFI 104 provides funds directly to branch 102, and the check provided for the withdrawal is issued from branch 102. Moreover, any PFIs 104 that use passbook accounts, branch 102 is operable to print on to the customer's 106 passbook transaction being conducted.

Another personal financial service provided by branch 102 is check cashing 506. In this service, checks that are provided from a bank account other than customer's 106 account at PFI 104 can be cashed. Further, customers 106 who want to transfer funds in form of a check that will be transferred immediately, branch 102 can issue a special voucher which can be cashed by voucher receiver. This enables the receiver to receive the cash without having to wait until funds actually clear. Alternatively, with the ascent of a depositor, another member of location can cash checks for immediate availability. Further, branch 102 preferably provides account balances and availability for checks to vendors with customer's 106 permission.

Yet another personal financial service provided by branch 102 is wire transfers 508. Using this feature, customers 106 can conduct wire transfers and branch 102 debits a customer's 106 account and wire funds to an institution to receive the funds. Alternatively, branch 102 issues instructions to a customer's 106 PFI 104 to complete transaction.

Another personal financial service provided by branch 102 includes an ability for customer 106 to order 510 various materials, typically paper materials, to effect banking. For example, customer 106 can order checks, deposit slips, withdrawals slips, and other paper products directly at branch 102. Customer 106 can order such paper products for his particular his account, and the request is either forwarded to the customer's 106 PFI 104 to complete, or, alternatively, branch 102 completes the order.

Another personal financial service provided by branch 102 includes enabling customer 106 to make password or other changes 512 to the customer's 106 ATM card. Preferably, customer 106 brings his banking ATM card to the branch 102 teller and uses a workstation 106 located at the teller to effect the password or other change.

Another personal financial service provided by branch 102 includes an ability for customer 106 to make mortgage payments 514. Preferably, customers 106 can bring in payment for mortgages for branch 102 to credit directly to mortgagee. Still another personal financial service provided by branch 102 includes providing account information, such as account balances 516 for customers 106.

Preferably, another personal financial service provided by branch 102 includes enabling customers 106 to apply for loans or open accounts 518. In one embodiment, video-conferencing stations provided with e-mail capabilities are available to review and submit complete loan applications. Photograph identification of customer 106 are preferably scanned for branch 102 and the scanned images are transmitted to PFI 104 to view and retain copies. Further, personnel at branch 102 certify they witnessed originals that were signed by customers 106. Preferably, the signed originals are retained by branch 102 to be later mailed to PFI 104.

Another personal financial service provided by branch 102 includes enabling customers 106 to open new accounts at any PFI 104. Preferably, branch 102 either requests new account information to be entered by PFI 104 or, alternatively, directly accesses databases provided by PFI 104 and enters new account information therein. Branch 102 preferably receives deposit materials (e.g., cash, checks or money orders) as capital for the new account. The deposit materials (or financial equivalents) are then deposited in PFI 104. Thereafter, customer 106 can access his new account either at branch 102 or directly at PFI 104.

In addition to the above, other miscellaneous services 522 are farther provided by branch 102. For example, branch 102 preferably sells money orders to customer 106.

Another miscellaneous personal financial service 522 includes interpreting services. For example, staff is provided at branch 102 who speak different languages. Moreover, video conferencing services are provided in various languages to assist foreign language speaking customers 106 and will include interpreters for customers 106 who need to speak to a PFI 106 (or an individual). Also, any individual willing to video conference to someone else in other area out of city, state or country will be able to use branch 102 facilities and be able to get interpreting service or video conferencing.

Another miscellaneous service 522 provided by branch 102 includes resources to communicate with a PFI 104. Preferably, branch 102 teller stations or locations within branch 102 where customers 106 can sit are include communications tools, such as email clients, for communicating with PFI 104. Further, a telephone may be provided with computer directory or manual directory for anyone who needs to call a PFI 104. Preferably, branch 102 tellers can review information, and/or branch 102 teller or customer service could be on-line at same time with the customer 105 and PFI 104 to lend appropriate assistance.

Further, ATM's are included in branch 102, and in a preferred embodiment, no additional fees are charged for customers 106 for accessing accounts held by PFIs 104. Further, a customer 106 can make a deposit in an ATM machine (or in a drop box) at branch 102, so long as the respective PFI 104 is indicated. For example, a unique PFI 104 code can be used for each PFI, a routing number for a PFI 104, or specially preprinted envelopes may be provided by branch 102. Further, safe deposit boxes are preferably located in branch 102.

Another miscellaneous service 522 provided by branch 102 includes mobile units that are available in case a branch 102 is temporarily cannot facilitate transactions, such as due to renovating, technical problems, fire, or the like, for its customers 106.

Another miscellaneous personal financial service 522 includes at home banking provided for customers 106. Preferably, machines for home or office use are provided enabling checks to be scanned to ready checks or provide pictures of checks for immediate deposit and this will be transferred to branch 102, for example, by email or other connection for immediate deposit into customer 106's account. In one embodiment, software may be provided to operate with a customer's 106 existing flatbed or other scanning device. Thereafter, customer 106 can bring the originals into branch 102 at his convenience or can simply destroy the originals. Advertising We will have a bulletin board or wall/walls or pamphlets that advertise banks or provide currant promotions we may have, such pamphlets will include an application to open an account or apply for a loan or credit card on line that can be dropped in a box for us to deliver to correct bank.

In accordance with the present invention drive-through branch 102 tellers are provided. Further, customers 106 can put in requests by telephone or internet and have an item waiting for them at branch 102 for immediate pick up. Alternatively, a customer 106 can request a pick up for deposits. Deposits can be requested for daily pick up as well.

As part of the business method of the present invention, fees are charged either from PFI 104 or from customer 106. For accounts that are billed to PFIs 104, billing is based on the following formulae

Fees are charged on a flat fees basis for depositors within a certain distance or geographical area (and may also based on depositors amounts);

Fees are charged on a per use or transaction; and/or

Fees are charged on a per member sign up process.

Further, credits are provided PFI 104 that have existing branches which operate as a branch 102.

For accounts being billed to customers 106, billing is based on the following formulae: fees are charged on a flat fee basis or fees are charged on a per use basis.

Thus the present invention provides substantial improvements over prior art bank and other financial institutions. Reduced bank fees and increased personal financial service are available for customers 106, while enabling branch 102 to realize profitability. Unlike the prior art, all bank transactions (such as deposits) can be executed at branch 102, regardless of the customer's 106 PFI 104. Further, every participating PFI 104 benefits by effectively increasing the number of branches the PFI 104 has. Personal financial service, e.g., services provided by a teller or officer, are provided to customers 106 at branch 106, thereby improving customer service provided by PFI's 104.

Although the present invention has been described in relation to particular embodiments thereof, many other variations and modifications and other uses will become apparent to those skilled in the art. It is preferred, therefore, that the present invention not be limited by the specific disclosure herein.

What is claimed is:

1. A method for providing personal financial services at a single branch location for customers having accounts at a plurality of different financial institutions, the method comprising:
receiving from a first customer first account information representing a first account held by the first customer at one of the plurality of private financial institutions;
receiving from a second customer second account information representing a second account held by the second customer at one other of the plurality of private financial institutions; and
providing the personal financial services to enable the first customer and the second customer to conduct transactions for their respective accounts.

2. The method of claim 1, further comprising transmitting electronic information representing the transactions to the first and second private financial institutions.

3. The method of claim 2, wherein the step of transmitting comprises formatting the electronic information according to instructions provided by the first and second private financial institutions.

4. The method of claim 1, wherein the personal financial services include enabling the first and second customers to at least make withdrawals, make deposits, cash checks, perform a wire transfer, order checking account materials, make mortgage payments and open new accounts.

5. The method of claim 1, further comprising providing a second branch providing the same personal financial services as provided by the single branch.

6. The method of claim 1, wherein the private financial institutions include savings and loan institutions, credit unions, community banks and stock brokerages.

7. The method of claim 1, further comprising providing an internet web site operable for the first and second customers to effect transactions for their respective accounts.

8. The method of claim 1, wherein the single branch is not owned by the plurality of private financial institutions.

9. A system for providing personal financial services for customers having accounts at a plurality of private financial institutions, the method comprising:
a branch location including a site processor that receives first account information representing a first account held by a first customer at one of the plurality of private financial institutions and second account information representing a second account held by a second customer at one other of the plurality of private financial institutions, wherein the branch location provides the personal financial services to enable the first customer and the second customer to conduct transactions for their respective accounts.

10. The system of claim 9, wherein the site processor is further operable to transmit electronic information representing the transactions to the first and second private financial institutions.

11. The system of claim 10, wherein the site processor is further operable to format the electronic information according to instructions provided by the first and second private financial institutions.

12. The system of claim 9, wherein the personal financial services include enabling the first and second customers to at least make withdrawals, make deposits, cash checks, perform a wire transfer, order checking account materials, make mortgage payments and open new accounts.

13. The system of claim 9, further comprising a second branch providing the same personal financial services as provided by the single branch.

14. The system of claim 9, wherein the private financial institutions include savings and loan institutions, credit unions, community banks and stock brokerages.

15. The system of claim 9, further comprising an internet web site provided on the information processor operable for the first and second customers to effect transactions for their respective accounts.

16. The system of claim 9, wherein the single branch is not owned by the plurality of private financial institutions.

17. A local bank branch facility, comprising:
an office space located at a given geographical location;
a plurality of teller stations located in the office space, each teller station comprising a respective teller station display and a respective data input device,
wherein the teller stations are coupled to a data processing center capable of processing financial transactions for banking customers who have accounts at a variety of banking institutions and the teller stations being effective to process information relevant to customers that have accounts at different banking institutions.

18. The facility of claim 17, wherein different ones of said teller stations are dedicated to respective corresponding ones of the banking institutions.

19. The facility of claim 17, wherein at least one of said teller stations is able to handle transactions of a variety of customers who have accounts at a variety of banking institutions.
